(19) United States
(12) Patent Application Publication
(10) Pub. No.: US 2016/0150014 A1
(43) Pub. Date: May 26, 2016

(54) DATA STORAGE DESTINATION

(71) Applicant: MICROSOFT TECHNOLOGY LICENSING LLC, Redmond, WA (US)

(72) Inventors: Marko Yliaho, Tampere (FI); Sami Säilä, Halikko (FI)

(21) Appl. No.: 14/548,760

(22) Filed: Nov. 20, 2014

(51) Int. Cl. H04L 29/08

(52) U.S. Cl. CPC H04L 67/1097

(57) ABSTRACT

In one example, a computing apparatus is configured to receive at least one contextual parameter. The computing apparatus is configured to receive an action from the user of the apparatus for a data item. The computing apparatus is configured to associate the at least one contextual parameter to the data item so as to establish a tag. The tag is configured to determine two or more data storage destinations of the data item. The computing apparatus is configured to output the suggested two or more data storage destinations of the data item for the user. One of the two or more data storage destinations is highlighted according to the tag. The data item destination may be automatically or manually selected to the appropriate data destination.

### BACKGROUND

When a computing apparatus, for example a mobile phone or a camera, is used to execute a data item, for example take a photo or open a document, typically the data item is applied at the computing apparatus for a short period of time. For example the photo image is shown on the display for a short period of time. After this the display goes back to a normal mode, for example in the camera appliance a viewfinder mode. Furthermore, it is common nowadays to store data items automatically to a cloud. This may be additionally to a local memory of the computing apparatus. It is also common to have accounts at different could services. Tagging this kind of photo is also common. The data item is tagged and processed at the cloud service. This may take place far later, than when the data item was originally used or executed.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In one example, a computing apparatus is configured to receive at least one contextual parameter. The computing apparatus is configured to receive an action from the user of the apparatus for a data item. The computing apparatus is configured to associate the at least one contextual parameter to the data item so as to establish a tag. The tag is configured to determine two or more data storage destinations of the data item. The computing apparatus is configured to output the suggested two or more data storage destinations of the data item for the user. One of the two or more data storage destinations is highlighted according to the tag.

In another examples a method and a computer program product has been discussed along with the features of the computing apparatus.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates execution of data item at computing apparatus, in accordance with an illustrative example;

FIG. 2 illustrates user interface of the computing apparatus comprising suggested data storage destinations, in accordance with an illustrative example;

FIG. 3 illustrates execution of data item at the computing apparatus, in accordance with an illustrative example;

FIG. 4 illustrates user interface of the computing apparatus comprising suggested data storage destinations, in accordance with an illustrative example;

FIG. 5 illustrates user interface of the computing apparatus comprising blocked data storage destinations, in accordance with an illustrative example;

FIG. 6 illustrates user interface of the computing apparatus comprising suggested data storage destinations, in accordance with an illustrative example;

FIG. 7 illustrates the user interface of the computing apparatus comprising an option for selecting all data destinations, in accordance with an illustrative example;

FIG. 8 illustrates a system for data storage destinations, in accordance with an illustrative example;

FIG. 9 is a schematic flow diagram of a method, in accordance with an illustrative example; and

FIG. 10 is a block diagram of one illustrative example of the computing apparatus.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

Although the present examples may be described and illustrated herein as being implemented in a smartphone or a mobile phone, these are only examples of a mobile apparatus and not a limitation. As those skilled in the art will appreciate, the present examples are suitable for application in a variety of different types of mobile apparatuses, for example, in tablets, phablets, computers, cameras, etc.

An example can determine an appropriate data storage destination considering the security aspects of the cloud services. For example, the user may want to have his/her business critical content in a One Drive For Business cloud service. Also, the user may use different cloud services for different types of content. For example, cloud A for images and could B for contacts; personal documents for private cloud services and business documents for business cloud services. Any business confidential photo, for example being captured with a phone, should not be allowed to end up to a wrong place. All these pictures will be tagged automatically, based on contextual parameters, resulting in a tag indicating the suggested data storage destinations. For example, a business tag or a private tag. The tag is used to channel data items to right places, before data items exit the mobile device. The tagging is performed at the computing apparatus, even starting before taking the picture, or the like data item. Several coexistent censoring methods maybe applied to perform the tagging. The suggested data storage destinations are automatically displayed to the user. The user interface can further highlight the preferred data storage destination. In an example, the user uses a swipe gesture on a touch display, when a captured image is shown to decide whether the image should be stored to local memory and/or to a cloud service and if to a cloud service, which one(s) of the could services the user uses. Confidential content does not end up to an unsecure area, like home computer's hard drive. Tag can also prevent company confidential pictures to leak. The suggested data storage destinations may be based on the tag. Some data storage destinations can be blocked, or not displayed at all.

The suggested data storage destinations and the highlighted data storage destination depend on the contextual parameters, based on which a tag is configured to be established for the data item.

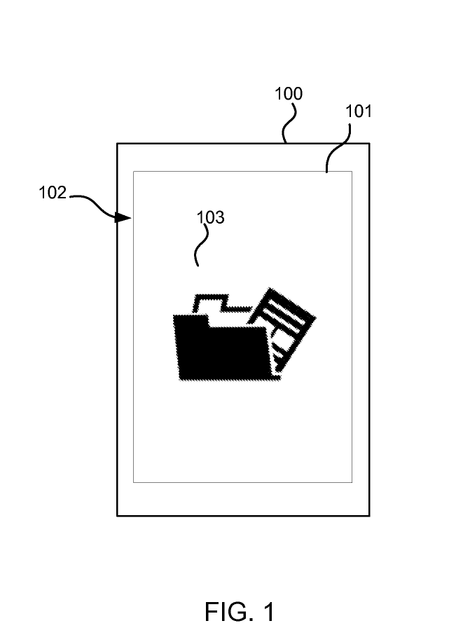

FIG. 1 illustrates a computing apparatus 100 executing a data item 103. The computing apparatus 100 may use or apply the data item 103. This may be due to the user's initiative or command. The computing apparatus 100, illustratively depicted as a smartphone in this example, executes the data item 103 in a display window 101 on a touchscreen 102, in accordance with an illustrative example. The computing apparatus 100 executes the data item 103. This may be for a relatively short period of time. The data item 103 is not necessarily permanently, for example for a long time period, stored at the computing apparatus 100 at this stage. The computing apparatus 100 has the data item 103 only temporarily, until a more permanent or a long time data storage destination is decided for the data item 103. For example, the user takes a photo by a smart phone. For another example, the user opens a document for editing purposes at the smart phone. In these examples, the photo or the document is temporarily stored at the computing apparatus 100. However, the final data storage destination is decided at the further processes as discussed later.

While FIG. 1 depicts example computing apparatus 100 in the form of a smartphone, as discussed other touchscreen-enabled computing devices may be used equivalently, such as tablet computers, netbook computers, laptop computers, desktop computers, processor-enabled televisions, personal digital assistants (PDAs), touchscreen devices connected to a video game console or set-top box, or any other computing device that has a touchscreen 102 and is enabled to play or execute a data item. In an example the computing apparatus 100 may not contain a touchscreen 102. Instead of touches gestures may be used as an input method.

The computing apparatus 100 comprises a display window 101, which is a graphical user interface element generated by a media application on an area of touchscreen 102, in which for example the media application displays the data item 103. The data item 103 being shown in display window 101 is depicted in a simplified view illustrating a document. The data item 103 may, for example, be a document, a video, a photo, a contact, a message and a note, etc. The data item 103 may further be voice recording, a link such as internet link, biometric data, sensor data such as speed acceleration, etc. The data item 103 may be such that a tag can be applied to the data item 103 depending on contextual parameters.

Touchscreen 102 may be a touch sensitive display such as a presence-sensitive screen, in that it is enabled to detect touch inputs from a user, including gesture touch inputs that include an indication, pointing, a motion with respect to the touch sensitive display, and translate those touch inputs into corresponding inputs made available to the operating system and/or one or more applications running on the apparatus 100. Various embodiments may include a touch-sensitive screen configured to detect touch, touch gesture inputs, or other types of presence-sensitive screen such as a screen device that reads gesture inputs by visual, acoustic, remote capacitance, or other type of signals, and which may also use pattern recognition software in combination with user input signals to derive program inputs from user input signals.

Furthermore, the touch sensitive area may be situated at a portion of the apparatus 100. For example, the touch sensitive area is not the same as display window 101. The touch sensitive area may be situated behind the apparatus 100 so that the display window 101 and touch sensitive area are on different sizes of the apparatus 100. The touch sensitive area may also be next to the display window 101.

In this example, during using the data item 103 on display window 101, computing apparatus 100 may accept a touch input in the form of a tap input, with a simple touch on touchscreen 102 without any motion along the surface of, or relative to, touchscreen 102. This simple tapping touch input without motion along the surface of touchscreen 102 may be equivalent and contrasted with a gesture touch input that includes motion with respect to the presence-sensitive screen, or motion along the surface of the touchscreen 102. The media application may detect and distinguish between simple tapping touch inputs and gesture touch inputs on the surface of touchscreen 102, as communicated to it by the input detecting aspects of touchscreen 102, and interpret tapping touch inputs and gesture touch inputs in different ways. Other aspects of input include double-tap; touch-and-hold, then drag; pinch-in and pinch-out, swipe, rotate. (Inputs and actions may be attributed to computing apparatus 100, throughout this disclosure, with the understanding that various aspects of those inputs and actions may be received or performed by touchscreen 102, the media application, the operating system, or any other software or hardware elements of or running on apparatus device 100.)

The input may also be a shake or tilt of the computing apparatus so that a direction of the shake or the tilt is configured to correspond to the input. Furthermore, twisting, bending, knocking, squeezing, holding differently may be used as the input method.

The data item 103 may be an image or a photo. For example an opened image or captured photo by a smart phone. For another example, captured images when watching them at the smart phone right after capturing them. For another example, images when watching them in photos application of the smart phone, in which case the images are already locally stored, but the user interface could show cloud services, where the images could also be stored. The data item 103 may also be a video. For example an opened or captured video file by a smart phone. The data item 103 may also be office documents such as word or excel files. The data item 103 may also be contacts of the user. Furthermore the data item 103 may be messages such as email messages or notes etc. Consequently, the data item 103 comprises any data for which determination of appropriate long term data storage is important. For example, a private data should be stored locally, or at the protected private cloud service. For another example, an access right may differentiate the data destinations so that physically the cloud service is the same, however an access right public or private distinguishes the these data destinations. For another example, business related data should be stored at the business data storage such as a protected business cloud service only.

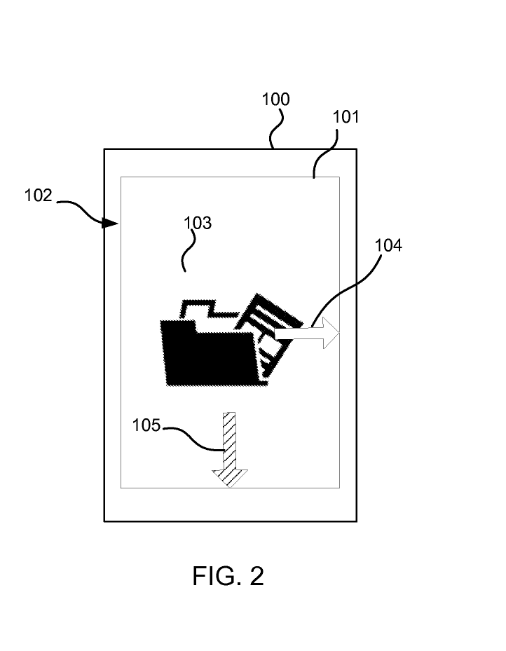

FIG. 2 illustrates user interface of the computing apparatus 100 comprising suggested data storage destinations 104,105. After the user, or the computing apparatus 100 automatically, has executed a data item 103, the computing apparatus 100 determines data storage destinations for the data item 103. In the example of FIG. 2, two data storage destinations 104,105 are determined for the data item 103. The data storage destinations 104,105 are outputted and suggested on the display 101, as illustrated by arrows 104,105 in FIG. 2. The user may select whether the data item 103 is stored to local data storage of the computing apparatus 100 by the arrow 105. The user may select whether the data item 103 is stored to data storage of the cloud service by the arrow 104. The selection may be by an input from the user. For example, user touches one of the arrows 104,105 on the touchscreen 102. In the example of FIG. 2, the local data storage of the computing apparatus 100 is highlighted as indicated by the filled arrow 105. This is suggested to the user by the highlighted arrow 105 as shown on the display 101.

Highlighted data destination can be displayed in various ways. It may have different colors than other data destinations shown. It may be of a different size, for example bigger, smaller.

In FIG. 2 the user may select the local data destination 104 by inputting this to the computer apparatus 100, for example by touching, swiping, tilting or making a gesture indicating this selection to the computing apparatus 100. The data item 103 is then stored at the local data storage of the computing apparatus 100 for long time storage. The data item 103 is not, in this case, stored to the cloud service.

The selection of the data storage destination takes place at the computing apparatus 100 quite instantly after executing the data item 103. This takes place before the data item 103 is finally stored, for example prior to sending the data item 103 to the cloud service or prior to the data item 103 is stored locally.

In an example, the data storing may be automatic. After the suggested data storage destination 105 is shown to the user, the computing apparatus 100 may automatically store the data item 103 to the selected data destination. For example, there is a certain time period, such as ten seconds, for showing the data storage destinations 104,105 for the user. If no input for selecting any one of these is received within this time period, the computing apparatus 100 automatically sends the data item to the highlighted data storage destination.

In another example, data item 103 will be tagged automatically with business indicating tag or a personal indicating tag. This tag will channel the data item 103 to right data destination. This may take place, when the data item 103 exits the computing apparatus 100. For example, data item 103 having a business tag is automatically stored to a business cloud service 106. Data item 103 having a personal tag is automatically stored to a personal cloud service 104. In this example, the data item 103 is automatically sent to the data destination, which is determined by the tag. User does not have the outputting option with the preferred data destination. The tag automatically channels the data item 103 to the data destination, which is indicated by the established tag.

In an example, the user may also override the highlighted data storage destination 105. The user may select the data storage destination 104, instead of the highlighted 105. The data item 103 is send to the cloud data storage 104 and not to the local data storage 105, according to the user selection.

In another example, the data destinations are displayed to user. The user may manually select the data destination. In this option the computing apparatus 100 displays available data destinations to user. The may simply manually select one of the displayed data destinations. The available data destinations may be showed to the user without highlighting one of the data destinations. The selection is based on a user action indicating the destination. For example, a swipe action on a touchscreen 102 channels the data item 103 to the selected data destination. In an example, the available data destinations are showed to the user without being tagged first. In this case, contextual parameters and tag may not be necessary.

Consequently, the data storages of the data item 103 can be categorized according to contextual parameters, and possibly the content of the data item 103. This may dependent on a tag determined for the data item 103. The tag is determined based on contextual parameters at the computing apparatus 100. This is processed and performed within the computing apparatus 100. This is also performed prior to the data item 103 is being executed. It may also be performed simultaneously, when the data item 103 is being executed, or a combination of prior to and at the same time. The computing apparatus 100 is configured for contextual parameters to use several coexisting censoring methods and devices. These are used in the tagging process. The computing apparatus 100 comprises a collaborative system that senses the people, activity, and context in the data item 103, and merges them carefully to create tags on-the-fly. This may be sensor assisted tagging using various sensors of the computing apparatus 100. For example, the tagging may be based on when-where-what-who format; <time, location, connection, contact, recognized pattern>. The computing apparatus 100 comprises sensing algorithms for creating the tag from the contextual parameters.

In an example, the tag may be added after the user has decided into which data destination, for example which cloud service, the data item 103 goes. In this example, the data items 103 are merely processed at the computing apparatus 100, and user has manually decided the data destination. After the selection the tag is established for the data item 103. The established tag may alter the selected data destination for the data item 103. For example, user may receive a notification that personal data destination 104 may contain business related data item 103.

Contextual parameter may be based on a location of the computing apparatus 100. For example, when the computing apparatus 100 is at the place of business or home, and this will be considered as one of the contextual parameters for establishing the tag. The location can be determined by GPS of the computing apparatus 100. The location may also be based on a semantic form of a location, such as name of a place (gym, airport, café), indoors or outdoors, or even descriptions of nearby landmarks, position at the map, etc.

Furthermore contextual parameters may be determined by a computing network such as based on a location of wlan, a mobile location within the mobile network, a computer network ip location etc. This is similar to a GPS location. Furthermore contextual parameters may be based on the connection type, affecting the tagging process. For example, secured business connection can be considered as one contextual parameter for establishing the tagging. For another example, a public network connection can be considered as a contextual parameter.

Contextual parameters may be based contacts of the user of the computing apparatus 100, which can affect the tagging process. For example, the computing apparatus 100 may receive information that a certain contact is in proximity or at the same meeting. The contact may be a business contact or a private contact.

Furthermore, contextual parameters may be based on a calendar of the user, which may be used for the tagging process. For example, at the time when the data item 103 is being executed at the computing apparatus 100, the calendar has a business or private meeting. Furthermore, contextual parameters can be based on time, which may be used for the tagging process. For example, the data item 103 is being executed at a weekend. Furthermore, time may be considered such as a precise time of the object, night or day.

Pattern recognition may be used for the tagging process. For example, a photo of a product is being taken, which is identified as a business product. Furthermore, a type of the data item may be used for contextual parameter. For example, the data item 103 comprises a business document or a private photo, etc. This may further apply accelerometer for determining a motion of the recognized pattern, a compass offset for recognizing the angle between the recognized pattern and the image capturing device. A person may be recognized in an image, which provides contextual parameter.

Even furthermore, the available contextual parameter may relate to what the object is doing. This may be sensed by accelerometer measuring motion of the object, microphone determining the sound of the object.

Each of the available contextual parameters is used for establishing the tag. For example an average value is calculated for establishing the tag. In an example, contextual parameters can be weighted differently with respect to each other. A tag is configured to indicate the preferred data storage destination. The tag is furthermore configured to indicate the suggested two or more data storage destinations.

For an example, the creation of the tag may be as follows. If contextual parameter location equals an office, then a tag indicating a business is created. This tag may have a normal emphasize. If contextual parameter location equals home, then a tag indicating a private is created. This tag may have a normal emphasize. If contextual parameter equals a colleague is present, then a tag indicating a business is created. This tag may have a normal emphasize. If contextual parameter equals a colleague being present and that a location equals home, then a tag indicating neutral is created. In this case the tag is neutral with respect to the business and private aspect. If contextual parameters indicate a colleague being present and a location is an office, then a tag indicating office is created. This tag may have a strong emphasize.

Merely as an example, when a photo of a business product is taken at the business premises (contextual parameter: location), during a business meeting (contextual parameter: calendar), being securely connected to a business network (contextual parameter: network), the tag being established from these contextual parameters is configured to suggest business cloud service for this photo. It may be a strong emphasize to business cloud service.

For another example, when a photo of a family person is taken at home (contextual parameter: location), during a private meeting (contextual parameter: calendar), being connected to home wlan by non-secured connection (contextual parameter: network), the tag being established from these contextual parameters is configured to suggest private data storage for this photo (either private cloud or local storage). This may have a strong emphasize indicating private data cloud or local storage.

For another example, a business document (contextual parameter: type of data item) is edited at home (contextual parameter: location), during a private meeting (contextual parameter: calendar), being connected to home wlan by non-secured connection (contextual parameter: network), the tag being established from these contextual parameters may be configured to suggest business data storage for this document. In this case, the type of the data item can be substantially weighted with respect to other contextual parameters. Consequently, the tag established from these contextual parameters is configured to suggest business data storage for this document.

Numerous example of the use of the contextual parameters for establishing a tag are available. Furthermore, they can be programmed differently, for example the weighting factors can be coded.

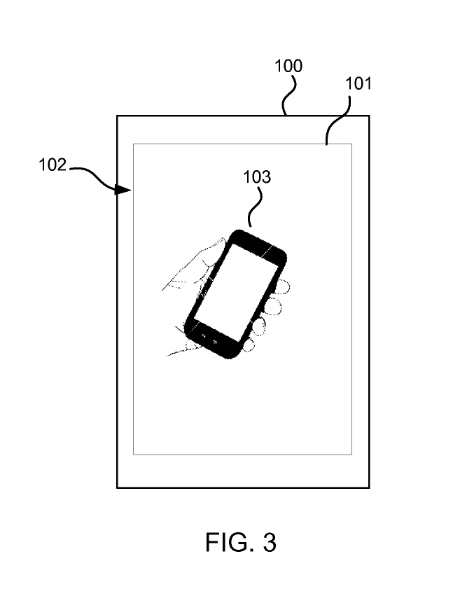

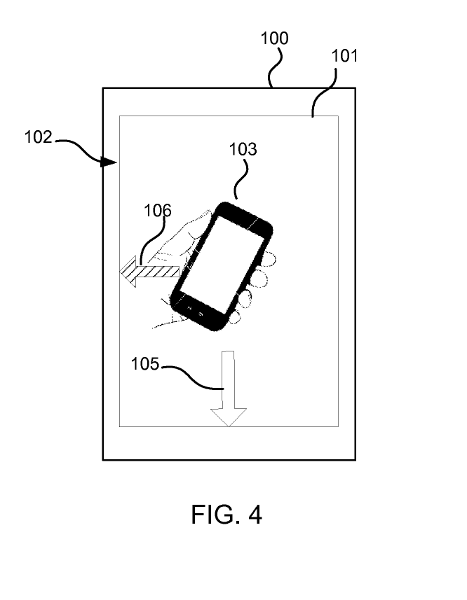

FIG. 3 illustrates an example, wherein the data item 103 comprises a captured photo of a product. For example in FIG. 3 the contextual parameter can be identified as business related due to the identified business product such as a mobile phone. FIG. 4 illustrates an example of FIG. 3, wherein a data destination 106 is highlighted. The user interface of the computing apparatus 100 comprises suggested data storage destinations 105,106. After the user, or the computing apparatus 100 automatically, has executed a data item 103, the computing apparatus 100 determines data storage destinations for the data item 103. In the example of FIG. 4, two data storage destinations 105,106 are determined for the data item 103. The data storage destinations 105,106 are outputted and suggested on the display 101, as illustrated by arrows 105,106. In the example of FIG. 4, the business cloud service is highlighted as indicated by the arrow 106. This is suggested to the user by the highlighted arrow 106 as shown on the display 101. Optionally, the user may select whether the data item 103 is stored to data storage of the computing apparatus 100 by the arrow 105. Preferably, the user may select whether the data item 103 is stored to data storage of the business cloud service by the arrow 106.

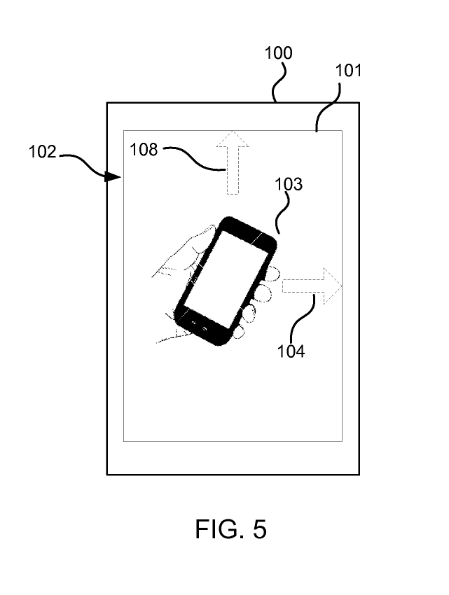

As discussed some of the data storage destinations maybe blocked. FIG. 5 illustrates an example of blocking data storage destinations. The data item 103 comprises a business sensitive object, for example a product of a company. In this example a mobile phone. The contextual parameters are configured to indicate this. For example the computing apparatus 100 can identify the object of the photo, and/or other contextual parameters affect this such as the business location, business network, business contacts nearby, etc. Consequently, the established tag indicates a business sensitive data item 103. In the example of FIG. 5, the computing apparatus 100 is configured to block the data storage options. The private cloud service data storage destination 104 is blocked. This is shown by the dashed arrow 104 in FIG. 5. Furthermore, the option to select all data storage destinations by an arrow 108 is blocked as shown by the dashed arrow 108. Because the private cloud service data storage destination 104 is blocked, the option to select all data storage destinations is blocked. In an example, the blocked data storage destinations are not displayed to the user. In another example, the blocked data storage destinations are displayed but differently from the operating data storage destinations, for example by dashed arrows.

In an example one or more data destination may be locked as only available data destination(s). For example a certain data destination is manually locked as only available data destination for any data item 103. For example, in case user is travelling abroad visiting a sub-contractor, there are no colleagues nearby, due to time difference, calendar may not have right working hours but may indicate night time hours, user is not nearby the office. Most of the contextual parameters would in this case indicate non-business. However, business tag may be manually locked by the user, so that all data items 103 are forced into the business data destination 106.

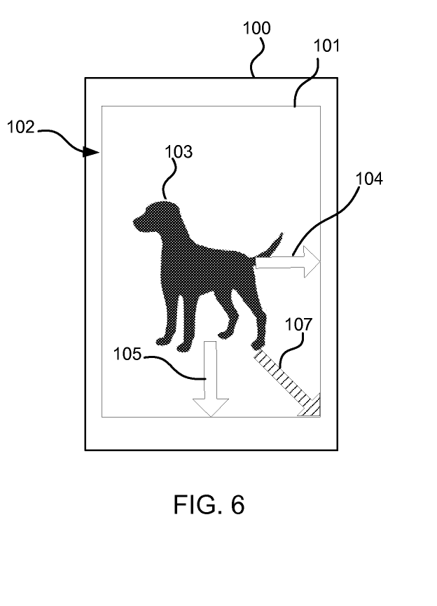

FIG. 6 shows one example of the user interface of the computing apparatus 100. The user can select whether the data item 103 is stored to the local data storage 105 of the computing apparatus 100, for example device's memory by a swipe down action. The user can also select to store the data item 103 to private cloud service 104 such as Onedrive by a swipe right action. Furthermore, the user can select both of them by a swipe action towards the bottom right corner on the touchscreen 102. This is highlighted by an arrow 107 on the display 101. In this example storing the data item 103 to both locally 105 at the computing apparatus 100 and to private cloud service 104 is highlighted. However, the user can select to store the data item 103 to only either one if he/she so prefers.

For an example Windows Phone OS has a setting for uploading images by default to cloud. The example of the figures may reflect that setting. If automatic upload is switched off, then the example of FIG. 2 is shown to the user after an image has been taken. Thus, by default the image is not uploaded to a cloud service, but the user could do that easily. If automatic image upload is switched on, then the example of FIG. 6 is shown to the user after an image has been taken. Thus, by default the image is stored locally and uploaded to cloud, but the user can easily select otherwise.

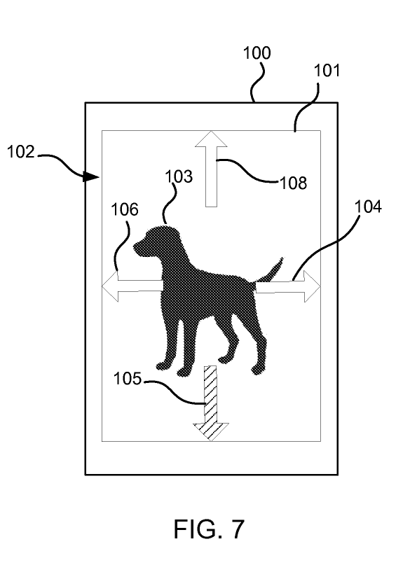

FIG. 7 illustrates the user interface of the computing apparatus comprising option for selecting all data destinations. FIG. 7 shows one example of the user interface implementation of the computing apparatus 100 where the user can select whether the data item 103 is stored to the local data storage destination 105 (for example device's memory by a swipe down action) or to private cloud service data storage destination 104 (for example private Onedrive by a swipe right action) or business cloud service data storage destination 106 (business cloud service by a swipe left action) or to all of them by an arrow 108 (for example swipe up). In FIG. 7 the user has an option for selecting to store the data item 103 to all suggested data storage by selecting the arrow 108. The user interface could also show other combinations of these, for example storing to both the cloud services 104,106, but not local 105.

Although the example user interfaces is illustrated using arrows, the invention is not limited to using exactly those user interface elements. Other symbols than arrows can be used, for example an image of a cloud and disc, etc. For another example, the user interface of the computing apparatus 100 can be coupled with cloud service. For example, a Onedrive symbol or a Dropbox symbol may appear on the display 101 of the user interface instead of the arrow, or in addition to it. In case these specific cloud services are available, the symbol can be output on the user interface.

In an example of installing a new data destination, for example a new cloud service application, to the apparatus 100, the operating system and/or the application may be configured to show that as a possible new data destination. The list of the data destinations may be dynamic. New data destinations can be configured to the apparatus 100 and become available on the UI for storage of the data items 103. Even further, the list of data destinations may be editable by the user so that he/she can organize what is shown in the UI. For example, user can select the available data destinations for the storage of the data items 103.

In an example, the user may give several inputs for selecting the data item 103 to be stored to two or more data storage destinations. For example, two swipe actions for arrows 104 and 106, based on which the data item 103 is stored to both business and private cloud data storage destinations 104,106.

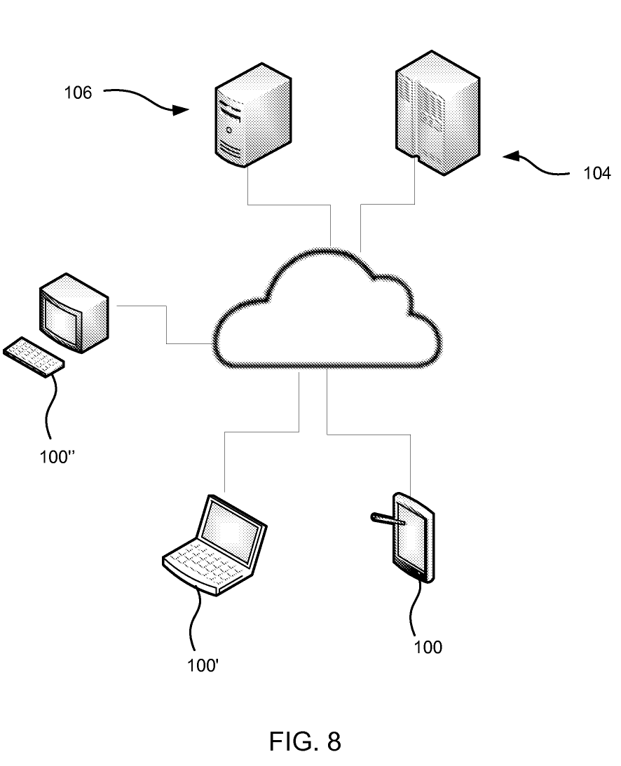

FIG. 8 illustrates an example of a system for data storage destinations. The system comprises different computing apparatuses 100,100′, and 100″. Furthermore the cloud services 104,106 are show.

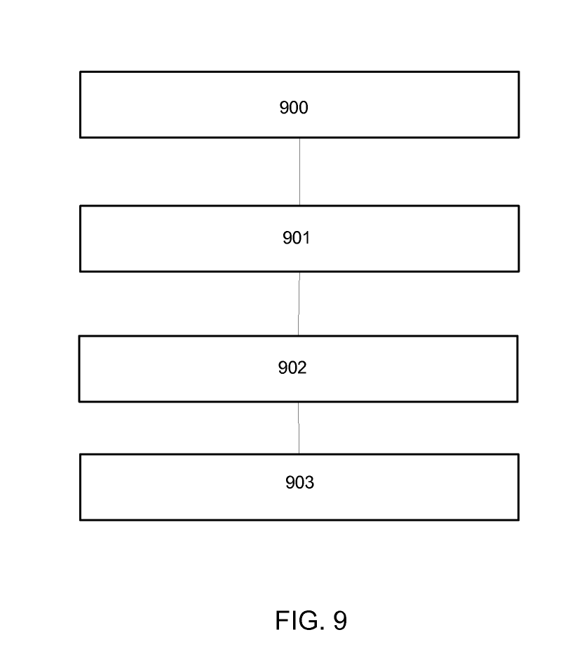

FIG. 9 is an example of a flow diagram of a method. In the step 900 the computing apparatus 100 receives at least one contextual parameter. The step 900 may apply the contextual parameters as discussed in the embodiments. In the step 901 the computing apparatus 100 receives an action from the user of the apparatus for a data item 103. The step 901 may apply the input actions for executing the data item 103 as discussed in the embodiments. In the step 902 the computing apparatus 100 associates the at least one contextual parameter to the data item so as to establish a tag. The tag is configured to determine two or more data storage destinations of the data item. The step 902 may apply the contextual parameters for establishing the tag as discussed in the embodiments. In the step 903 the computing apparatus 100 outputs the suggested two or more data storage destination of the data item for the user. One of the two or more data storage destinations is highlighted according to the tag. The step 903 may apply the outputting and highlighting as discussed in the embodiments.

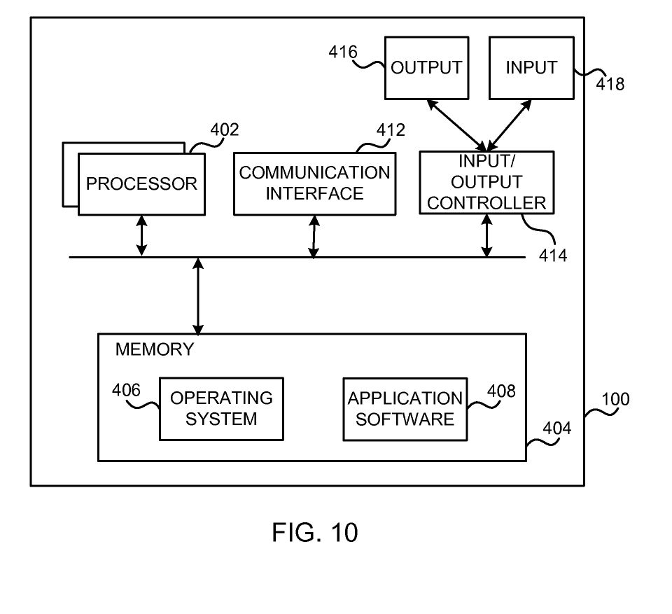

FIG. 10 illustrates an example of components of a computing apparatus 100 which may be implemented as any form of a computing and/or electronic device. The computing apparatus 100 comprises one or more processors 402 which may be microprocessors, controllers or any other suitable type of processors for processing computer executable instructions to control the operation of the apparatus 100. Platform software comprising an operating system 406 or any other suitable platform software may be provided at the apparatus to enable application software 408 to be executed on the device.

Computer executable instructions may be provided using any computer-readable media that is accessible by the apparatus 100. Computer-readable media may include, for example, computer storage media such as memory 404 and communications media. Computer storage media, such as memory 404, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 404) is shown within the apparatus 100 it will be appreciated that the storage may be distributed or located remotely and accessed via a network or other communication link (e.g. using communication interface 412).

The apparatus 100 may comprise an input/output controller 414 arranged to output information to a output device 416 which may be separate from or integral to the apparatus 100. The input/output controller 414 may also arranged to receive and process input from one or more input devices 418, such as a user input device (e.g. a keyboard, camera, microphone or other sensor). In one example, the output device 416 may also act as the user input device if it is a touch sensitive display device, and the input is the gesture input such as a touch. The input/output controller 414 may also output data to devices other than the output device, e.g. a locally connected printing device.

The input/output controller 414, output device 416 and input device 418 may comprise natural user interface, NUI, technology which enables a user to interact with the computing apparatus 100 in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods). The presence sensitive display 102 may be a NUI.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

The term ‘computer’, ‘computing-based device’, ‘apparatus’ or ‘mobile apparatus’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods and functionalities described herein may be performed by software in machine readable form on a tangible storage medium e.g. in the form of a computer program comprising computer program code means adapted to perform all the functions and the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any range or device value given herein may be extended or altered without losing the effect sought. Also any example may be combined to another example unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A computing apparatus comprising:
at least one processor, and
at least one memory storing program instructions that, when executed by the at least one processor, cause the apparatus to:
receive at least one contextual parameter;
receive an action from the user of the apparatus for a data item;
associate the at least one contextual parameter to the data item so as to establish a tag, wherein the tag is configured to determine two or more data storage destinations of the data item;
output the two or more data storage destinations of the data item for the user, wherein one of the two or more data storage destinations is highlighted according to the tag.

2. The computing apparatus of claim 1, wherein the at least one memory store program instructions that, when executed, cause the apparatus to:
establish the tag at the computing apparatus before the computing apparatus is configured to store the data item at one of the two or more data storage destinations.

3. The computing apparatus of claim 1, wherein the at least one memory store program instructions that, when executed, cause the apparatus to:
receive an input from the user for selecting one of the two or more data storage destinations for storing the data item.

4. The computing apparatus of claim 1, wherein the at least one memory store program instructions that, when executed, cause the apparatus to: automatically send the data item to the highlighted data storage destination.

5. The computing apparatus of claim 3, wherein the at least one memory store program instructions that, when executed, cause the apparatus to: according to the input, send the data item to the selected data storage destination or to selected data storage destinations.

6. The computing apparatus of claim 3, wherein the selected data storage is different from the highlighted data storage destination.

7. The computing apparatus of claim 3, wherein the at least one memory store program instructions that, when executed, cause the apparatus to:
override the highlighted storage destination indicated by the at least one tag, and based on the input, send the data item to the user selected storage destination.

8. The computing apparatus of claim 1, wherein the at least one memory store program instructions that, when executed, cause the apparatus to:
wherein one of the two or more data storage destinations of the data item comprises a local data storage destination at the computing apparatus.

9. The computing apparatus of claim 1, wherein the at least one memory store program instructions that, when executed, cause the apparatus to: temporarily store the data item at a temporary storage of the computing apparatus with the tag.

10. The computing apparatus of claim 9, wherein the at least one memory store program instructions that, when executed, cause the apparatus to: delete the data item and the tag from the temporary storage, when the data item is send to one of the two or more data storage destination.

11. The computing apparatus of claim 1, wherein the two or more data storage destination comprises network data storage destinations and a local data storage destination at the computing apparatus.

12. The computing apparatus of claim 1, wherein the at least one contextual parameter is based on a location of the computing apparatus, a connection of the computing apparatus, contacts of the user of the computing apparatus, a calendar of the user of the computing apparatus, and a time.

13. The computing apparatus of claim 1, wherein the action comprises capturing at least one image for establishing the data item or opening the data item.

14. The computing apparatus of claim 1, wherein the data item comprises a document, a video, an image, a photo, a contact, a message, audio recording, computer program or a note.

15. The computing apparatus of claim 3, wherein the input comprises a touch of the user on a touch sensitive display of the computing apparatus, wherein the input comprises a swipe action of the user on a touch sensitive display of the computing apparatus, wherein the input comprises a tilt of the computing apparatus so that a direction of the tilt is configured to correspond to the input, or wherein the input comprises a shake of the computing apparatus so that a direction of the shake is configured to correspond to the input.

16. The computing apparatus of claim 1, wherein one of the two or more data storage destinations is locked so that it is the only available data destination and highlighted.

17. The computing apparatus of claim 1, wherein the two or more data storage destinations are dynamic so that the two or more data storage destinations are based on installed data destinations of the computing apparatus.

18. The computing apparatus of claim 1, wherein the at least one memory store program instructions that, when executed, cause the apparatus to: block at least one of the two or more data storage destinations.

19. A computer-readable storage medium comprising executable instructions for causing at least one processor of a computing apparatus to perform operations comprising:
receive at least one contextual parameter;
receive an action from the user of the apparatus for a data item;
associate the at least one contextual parameter to the data item so as to establish a tag, wherein the tag is configured to determine two or more data storage destinations of the data item; and
output the two or more data storage destinations of the data item for the user, wherein one of the two or more data storage destinations is highlighted according to the tag.

20. A method, comprising
receiving at least one contextual parameter;
receiving an action from the user of the apparatus for a data item;
associating the at least one contextual parameter to the data item so as to establish a tag, wherein the tag is configured to determine two or more data storage destinations of the data item; and
outputting the two or more data storage destinations of the data item for the user, wherein one of the two or more data storage destinations is highlighted according to the tag.
